(19) United States
(12) Patent Application Publication
(10) Pub. No.: US 2008/0237059 A1
(43) Pub. Date: Oct. 2, 2008

(54) Electrolysis treatment apparatus, support for planographic printing plate, planographic printing plate, and electrolysis treatment process

(75) Inventors: Yuichi Kasuya, Shizuoka-ken (JP); Yutaka Kashiwabara, Shizuoka-ken (JP)

Correspondence Address: TAIYO CORPORATION, 401 HOLLAND LANE, #407, ALEXANDRIA, VA, 22314, US

(73) Assignee: FUJIFILM CORPORATION, Minato-ku (JP)

(21) Appl. No.: 12/076,869

(22) Filed: Mar. 25, 2008

(30) Foreign Application Priority Data
Mar. 30, 2007 (JP) 2007-093710

(51) Int. Cl. C02F 1/461; C25F 7/00

(52) U.S. Cl. 205/687; 204/275.1; 204/297.01

(57) ABSTRACT

An electrolysis treatment apparatus for performing electrolytically treating a metal strip that is running in a certain direction is provided. A number of electrolysis cells continuously perform the electrolysis treatment with alternating currents in acidic electrolyte solutions. The electrolysis cells are arranged in series along the running direction of the metal strip. In each of the electrolysis cells, one electrode or two or more electrodes is/are provided. Each electrode is disposed so as to face a running path of the metal strip and applies alternating current. A soft start portion is provided at an entry region of the electrode at which the metal strip is fed in. Current density of the alternating current in the plural electrolysis cells is set so as to be the lowest in the electrolysis cell disposed furthest downstream with respect to the running direction of the metal strip. In at least one electrolysis cell except the electrolysis cell that is disposed furthest downstream. A low current density zone is provided at an exit region at which the metal strip is fed out.

### CROSS-REFERENCE TO RELATED APPLICATION

This application claims priority under 35 USC 119 from Japanese Patent Application No. 2007-093710, the disclosure of which is incorporated by reference herein.

### BACKGROUND OF THE INVENTION

1. Field of the Invention

The present invention relates to an electrolysis treatment apparatus, a support for a planographic printing plate, a planographic printing plate, and an electrolysis treatment process.

2. Description of the Related Art

The present invention relates to an electrolysis treatment apparatus and an electrolysis treatment process, and particularly relates to an electrolysis treatment apparatus and electrolysis treatment process capable of effectively suppressing occurrences of chatter marks on the surface of a metal strip even when the electrolysis treatment is performed on the metallic plate continuously under a high current density and at a high conveyance speed.

A planographic printing original plate, which is an original plate for a planographic printing plate, is generally manufactured by a procedure in which: a surface of a plate of pure aluminium or an aluminium alloy (below referred to as ‘aluminium or the like’) is roughened; then an anodization treatment is performed so that an anodization film is formed on the roughened surface, thus providing a support for the planographic printing plate; and a photosensitive or heat-sensitive platemaking layer is formed on the surface of the planographic printing plate support on which the anodization film has been formed.

Hence, a printing image of text, a picture or the like is printed into the plate-making layer of the planographic printing plate and developed, and thus a planographic printing plate is produced.

The aluminium plate is surface-roughened by: a mechanical surface-roughening treatment with a brush roller featuring fibers of nylon or the like, an abrasive roller with a surface formed with an abrasive cloth, or the like; an etching treatment wherein a surface of the aluminium plate is chemically roughened in an alkaline bath; an electrolytic surface-roughening treatment wherein electrolytic surface-roughening is performed with the aluminium plate serving as one electrode; or the like (see Japanese Patent Application Laid-Open (JP-A) Nos. 60-067700 and 1-230800).

Now, the electrolytic surface-roughening is usually performed by applying an alternating current such as a sinusoidal current, a rectangular wave current, a trapezoid wave current or the like to the aluminium plate in an acidic electrolyte solution. Thus, positive voltage and negative voltage are alternatingly applied to the aluminium plate at an entrance of an electrolysis cell.

A cathode reaction takes place at the aluminium plate when a positive voltage is applied, and an anode reaction takes place when a negative voltage is applied. At the time of the cathode reaction, an oxide film of which principal component is aluminium hydroxide is formed, and at the time of the anode reaction, the oxide film is electrolyzed and honeycomb-like small holes called pits are formed.

Therefore, when a positive voltage is being applied at the entrance of the electrolysis cell, the cathode reaction occurs first at the aluminium plate that is passing through the electrolysis cell, and when a negative voltage is being applied, the anode reaction occurs first. As a result, surface conditions of the aluminium plate vary in accordance with the polarity of the voltage that is applied at the entrance of the electrolysis cell, and surface quality defects in the form of stripes extending in a width direction of the aluminium plate, that is, chatter marks, takes place. In particular, the occurrence of chatter marks is especially noticeable when the electrolytic-roughening treatment is implemented at a high conveyance speed and under a high current density.

As a method for suppressing the occurrence of chatter marks, for example, the following processes have been proposed: an electrolysis treatment apparatus in which a soft zone which applies low current density treatment is provided at an entry aperture region of an electrolysis cell (refer to Japanese Patent Application Laid-Open(JP-A) No. 60-067700); an electrolysis treatment apparatus in which low current density zones are provided at a leading end and trailing end of each electrode in an electrolysis cell, and a region of the rest of the electrode is a constant current density zone (refer to Japanese Patent Application Laid-Open(JP-A) No. 1-230800); and an electrolysis treatment apparatus in which the electrolysis treatment apparatus is provided with a soft start region at an entry aperture region of an electrolysis cell, and a length of the soft start region is determined so as to satisfy a particular relationship with a current density of the soft start region, a section length and a metal strip conveyance speed (see JP-A No. 2003-003299).

Furthermore, an electrolysis treatment apparatus having a number of electrolysis cells arranged in series wherein current density is set so that the lowest current density is applied to the furthest downstream electrolysis cell is proposed (see JP-A No. 2003-171800).

However, even by using the electrolysis treatment apparatus mentioned above, it has been difficult to completely suppress occurrences of chatter marks when an electrolytic surface-roughening treatment is performed at a high conveyance speed and under a high current density.

### SUMMARY OF THE INVENTION

The present invention has been made in order to solve the problem described above, and a first aspect for solving the problem relates to an electrolysis treatment apparatus that performs electrolysis treatment on a metal strip running in a predetermined direction, the electrolysis treatment apparatus comprising: a plurality of electrolysis cells that perform electrolysis treatment continuously with alternating current in an acidic electrolyte solution, the electrolysis cells being arranged in a row along the running direction of the metal strip, and current density of the alternating current in the plurality of electrolysis cells being set so as to be lowest in the electrolysis cell that is disposed furthest downstream with respect to the running direction of the metal strip; in each of the electrolysis cells, one or more electrodes being disposed so as to face a running path of the metal strip, alternating current being applied to the electrodes, and a soft start portion being provided at an entry region of each electrode from which entry region the metal strip is fed in; in the electrolysis cell(s) except the most downstream electrolysis cell, a low current density zone being provided at an exit region from which the metal strip is fed out.

### BRIEF DESCRIPTION OF THE DRAWINGS

FIG. 1 is a schematic diagram showing structure of an electrolysis treatment apparatus relating to a first embodiment.

FIG. 2 is a schematic diagram showing structure of an electrolysis treatment apparatus relating to a second embodiment.

FIG. 3 is a schematic diagram showing structure of an electrolysis treatment apparatus relating to a third embodiment.

FIG. 4 is a schematic diagram showing structure of an electrolysis treatment apparatus used for Examples 1 to 5, Reference Example 1 and Comparative Examples 1 to 4.

### DETAILED DESCRIPTION OF THE INVENTION

### 1. First Embodiment

An example of an electrolytic surface-roughening treatment apparatus performing electrolytic surface-roughening treatment on an aluminium strip to form a support for a planographic printing plate, which is an example of the electrolysis treatment apparatus of the present invention will be described below.

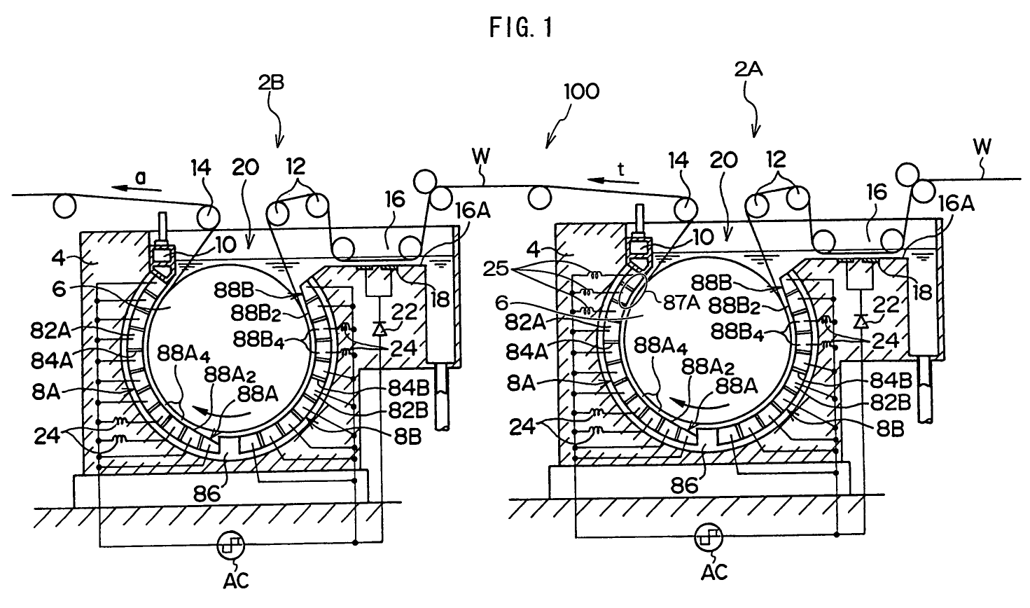

As shown in FIG. 1, an electrolytic surface-roughening treatment apparatus 100 relating to a first embodiment is provided with an electrolysis cell 2A that is disposed at an upstream side with respect to a conveyance direction t of an aluminium strip W and an electrolysis cell 2B that is disposed at the downstream side of the electrolysis cell 2A with respect to the conveyance direction t.

Each of the electrolysis cells 2A and 2B is equipped with an electrolysis cell main body 4 and a feeding roller 6. The electrolysis cell main body 4 retains an acidic electrolyte solution. The feeding roller 6 is arranged in a horizontal direction inside the electrolysis cell main body 4, and turns around an axis thereof in the clockwise direction of FIG. 1 to feed the aluminium strip W along the conveyance direction t.

An inner wall face of the electrolysis cell main body 4 is formed in a substantially cylindrical shape, and half-cylinder-form electrodes 8A and 8B are provided on the inner wall surface so as to encircle the feeding roller 6.

The electrodes 8A and 8B are divided-type electrodes which are divided along the circumferential direction into pluralities of small electrodes 82A and 82B, respectively. Insulation layers 84A and 84B are interposed between the small electrodes 82A and 82B, respectively.

The small electrodes 82A and 82B can be formed using, for example, graphite, a metal or the like, and the insulation layers 84A and 84B can be formed of, for example, a vinyl chloride resin or the like.

Thicknesses of the insulation layers 84A and 84B are preferably 1 to 10 mm.

In both the electrodes 8A and 8B, the small electrodes 82A and 82B are respectively connected to an Alternating current power supply AC. The small electrodes 82A and 82B and the insulation layers 84A and 84B are all retained by an insulating electrode holder 86, and thus the electrodes 8A and 8B are formed.

The Alternating current power supply AC applies alternating currents to the electrodes 8A and 8B. The Alternating current power supply AC may be a sinusoidal wave generation circuit, which generates a sinusoidal wave by adjusting voltage and current of a commercial alternating current by using an inductive voltage regulator and a transformer, a thyristor circuit, which generates a trapezoid wave current or a rectangular wave current from a direct current that is obtained by a method such as rectifying a commercial alternating current, or the like.

At an upper portion of each of the electrolysis cells 2A and 2B, an aperture portion 20 for feeding in and out the aluminium strip W is formed. An acidic electrolyte solution replenishment channel 10, which replenishes the acidic electrolyte solution in the electrolysis cell main body 4, is provided at the aperture portion 20 in the vicinity of a downstream side end of the electrode 8B. Nitric acid, sulfuric acid, hydrochloric acid, phosphoric acid and sulfonic acid are examples of an acidic electrolyte that can be incorporated into the acidic electrolyte solution. Only one kind of acidic electrolyte or two or more kinds of acidic electrolytes may be incorporated. Besides the acidic electrolyte, aluminium ions and the like may be incorporated in the acidic electrolyte solution.

A group of upstream side guide rollers 12 and a downstream side guide roller 14 are disposed above the electrolysis cell 2A or 2B in the vicinity of the aperture portion 20. The upstream side guide rollers 12 guide the aluminium strip W into the electrolysis cell 2A or 2B. The downstream side guide roller 14 guides the aluminium strip W that has been subjected to electrolytic surface-roughening treatment in the electrolysis cell 2A or 2B toward the outside thereof.

At each of the electrolysis cells 2A and 2B, an auxiliary electrolysis cell 16 is provided adjacent to the upstream side of the electrolysis cell main body 4. The auxiliary electrolysis cell 16 is shallower than the electrolysis cell main body 4, and a floor 16A is formed as a horizontal surface. A plate-form auxiliary electrode 18 is disposed above the floor 16A.

The auxiliary electrode 18 is preferably formed of a highly corrosion-resistant metal such as platinum or the like, or a ferrite or the like, and can be rod-shaped.

The auxiliary electrode 18 is connected to the alternating current power supply AC at a side to which the electrode 8B is connected in parallel with the electrode 8B. Between the auxiliary electrode 18 and the Alternating current power supply AC, a diode 22 is connected such that electric current flow in the direction from the Alternating current power supply AC to the auxiliary electrode 18.

At each of the electrolysis cells 2A and 2B, soft start portions 88A and 88B are provided at upstream side end portions of the electrodes 8A and 8B, respectively.

The soft start portions 88A and 88B include, respectively, asymptotic portions 88A₂ and 88B₂ and, located at the downstream sides of the asymptotic portions, inductance inclusion portions 88A₄ and 88B₄. The asymptotic portions 88A₂ and 88B₂ are sections that are asymptotic to the surface of the feeding roller 6, along the conveyance direction t. The inductance inclusion portions 88A₄ and 88B₄ are sections at which inductance coils 24 are included between the small electrodes 82A or 82B and the Alternating current power supply AC.

In the upstream side electrolysis cell 2A, a low current density zone 87A is formed, located at the downstream side of the conveyance direction t, that is, at the side of feeding out of the aluminium strip W. At the low current density zone 87A, inductance coils 25 are included between the small electrodes 82A of the electrode 8A and the Alternating current power supply AC. The low current density zone 87A is preferably formed such that a treatment time duration of the aluminium strip W thereat is at least 6% of an overall treatment time duration of the aluminium strip W in the electrolysis cell 2A.

A current density of the alternating current applied to the electrodes 8A and 8B in the electrolysis cell 2A is higher than a current density of the alternating current applied to the electrodes 8A and 8B in the electrolysis cell 2B, with the former being preferably 1.2 to 2 times higher than the latter. The current densities in the electrolysis cells 2A and 2B are defined as average current densities, including the soft start portions 88A and 88B and the low current density zone 87A.

The current density of the alternating current applied to the electrodes 8A and 8B in the electrolysis cell 2B is preferably in a range from 15 to 30 A/dm². Inductances of the inductance coils 25 are specified such that a ratio d/D between a current density d (A/dm²) at the low current density zone 87A and a current density D (A/dm²) of other regions will be 0.75 or less, preferably in the range from 0.3 to 0.75.

Note that resistors could be used in place of the inductance coils 24 and 25 at the soft start portions 88A and 88B and the low current density zone 87A, and that otherwise the soft start portions 88A and 88B and the low current density zone 87A are connected to a different power supply that a power supply to which the rest portions of the electrodes 8A and 8B are connected.

Function of the electrolytic surface-roughening treatment apparatus 100 shown in FIG. 1 will be described below.

The aluminium strip W is guided to the electrolysis cell 2A from the right side of FIG. 1, and is first fed into the auxiliary electrolysis cell 16 and subjected to an anode reaction. Then, the aluminium strip W is fed into the electrolysis cell main body 4 by the upstream side guide rollers 12.

The aluminium strip W is conveyed along the conveyance direction t inside the electrolysis cell main body 4 by the feeding roller 6, and first passes through the soft start portion 88B. At an upstream side end portion, that is, a start point of the soft start portion 88B, the current density is much smaller than a current density MC_{A} of the alternating current that is applied to the electrolysis cell 2A. The current density increases as the aluminium strip W moves to the downstream side, and is equal to the current density MC_{A} at a downstream side end portion, that is, an end point of the soft start portion 88B.

After the aluminium strip W has passed through the soft start portion 88B, the aluminium strip W is conveyed along the electrode 8B of the electrolysis cell main body 4, and a surface at the side of the aluminium strip W that opposes the electrode 8B is subjected to anode and cathode reactions by the alternating current that is applied from the Alternating current power supply AC to the electrode 8B.

The aluminium strip W that has passed along the electrode 8B then passes through the soft start portion 88A formed in the electrolysis cell main body 4. At the soft start portion 88A, similarly, the current density is much smaller at a start point than the current density MC_{A}, increases as the aluminium strip W moves to the downstream side, and is equal to the current density MC_{A} at an end point.

After the aluminium strip W has passed through the soft start portion 88A, similarly, the aluminium strip W is conveyed along the electrode 8A, the surface of the side that opposes the electrode 8A is subjected to anode and cathode reactions by the alternating current that is applied from the Alternating current power supply AC to the electrode 8A, and honeycomb pits are formed over the whole surface. Finally, the aluminium strip W passes through the low current density zone 87A.

The aluminium strip W that has been subjected to the electrolytic surface-roughening treatment in the electrolysis cell main body 4, after passing through the low current density zone 87A, is fed out of the electrolysis cell 2A by the downstream side guide roller 14.

The aluminium strip W that has been fed out from the electrolysis cell 2A is then guided to the electrolysis cell 2B.

The aluminium strip W that has been guided to the electrolysis cell 2B is first fed into the auxiliary electrolysis cell 16 and subjected to the anode reaction.

The aluminium strip W is then fed into the electrolysis cell main body 4 by the upstream side guide rollers 12. In the electrolysis cell main body 4 provided at the electrolysis cell 2B too, current densities are smaller than a current density MC_{B} of the electrolysis cell 2B at the start points of the soft start portions 88A and 88B and are equal to the current density MC_{B} at the end points of the soft start portions 88A and 88B. Hence, the electrolytic surface-roughening treatment is performed with the current density MC_{B} at downstream sides from the soft start portions 88A and 88B.

Herein, the current density MC_{B} of the electrolysis cell 2B is smaller than the current density MC_{A} of the electrolysis cell 2A, specifically being in a range from MC_{A}/1.2 to MC_{A}/2.

The aluminium strip W that has passed through the electrolysis cell main body 4 of the electrolysis cell 2B is fed out from the electrolysis cell main body 4 by the downstream side guide roller 14.

Now, the alternating currents applied to the electrolysis cells 2A and 2B may be trapezoid wave currents, or alternatively, sinusoidal wave currents or rectangular wave currents. Furthermore, currents in which a direct current is superimposed with a trapezoid current, a sinusoidal wave current or a rectangular wave current are to be included.

In the electrolytic surface-roughening treatment apparatus 100 relating to the first embodiment, the electrolytic surface-roughening treatment is implemented with the current density in the electrolysis cell 2B disposed at furthest downstream side being 1/1.2 to ½ the current density in the upstream side electrolysis cell 2A. Therefore, the surface quality defects described by the phrase “problem to be solved by the invention” are particularly unlikely to occur.

Moreover, the soft start portions 88A and 88B and the low current density zone 87A are provided in the electrolysis cell main bodies 4 of the electrolysis cell 2A. Therefore, in both of the electrolysis cells 2A and 2B, current with a low current density is initially applied to the aluminium strip W. Further, because the low current density zone 87A is formed at an exit of the electrolysis cell 2A, chatter marks will not occur even when the conveyance speed of the aluminium strip W is high in a case in which the surface-roughening is performed with large current densities, and uniform honeycomb-like pits will be formed over the whole of the roughened surface of the aluminium strip W.

### 2. Second Embodiment

Another example of an electrolytic surface-roughening treatment apparatus, to be included in the electrolysis treatment apparatus of the present invention, will be described herebelow.

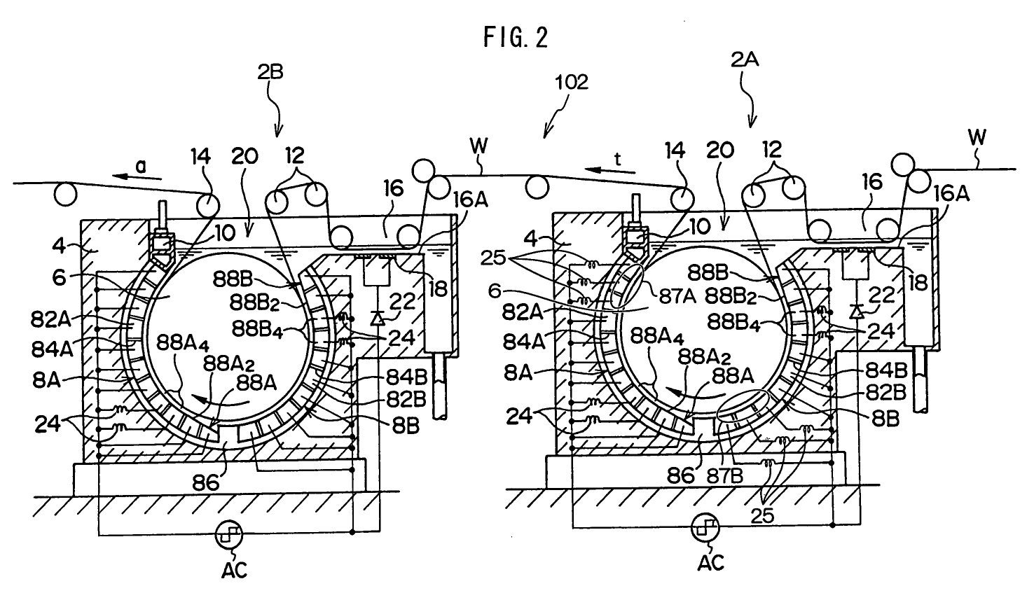

As shown in FIG. 2, the low current density zone 87A is formed in the electrolysis cell 2A at the upstream side of an electrolytic surface-roughening treatment apparatus 102 relating to the second embodiment. The low current density zone 87A is disposed at the downstream side along the conveyance direction t, that is, at the side of feeding out of the aluminium strip W, and the inductance coils 25 are included between the small electrodes 82A at the exit side of the electrode 8A and the Alternating current power supply AC. Similarly, at the exit side of the electrode 8B, which is disposed at an upstream side with respect to the conveyance direction t, i.e., at a side wherein the aluminium strip W is fed, the inductance coils 25 are included between the small electrodes 82B and the Alternating current power supply AC to form a low current density zone 87B. Additionally, as the low current density zone 87A, the low current density zone 87B is preferably formed such that a treatment time duration of the aluminium strip W thereat is 6% or more of an overall treatment time duration of the aluminium strip W in the electrolysis cell 2A.

Apart from these points, the electrolytic surface-roughening treatment apparatus 102 has structure the same as the electrolytic surface-roughening treatment apparatus relating to the first embodiment. In the electrolytic surface-roughening treatment apparatus 102, current densities of the electrolysis cells 2A and 2B are defined as average current densities in the electrolysis cells, including the soft start portions 88A and 88B and the low current density zones 87A and 87B.

### 3. Third Embodiment

Yet another example of an electrolytic surface-roughening treatment apparatus, which is included in the electrolysis treatment apparatus of the present invention, will be described in the below.

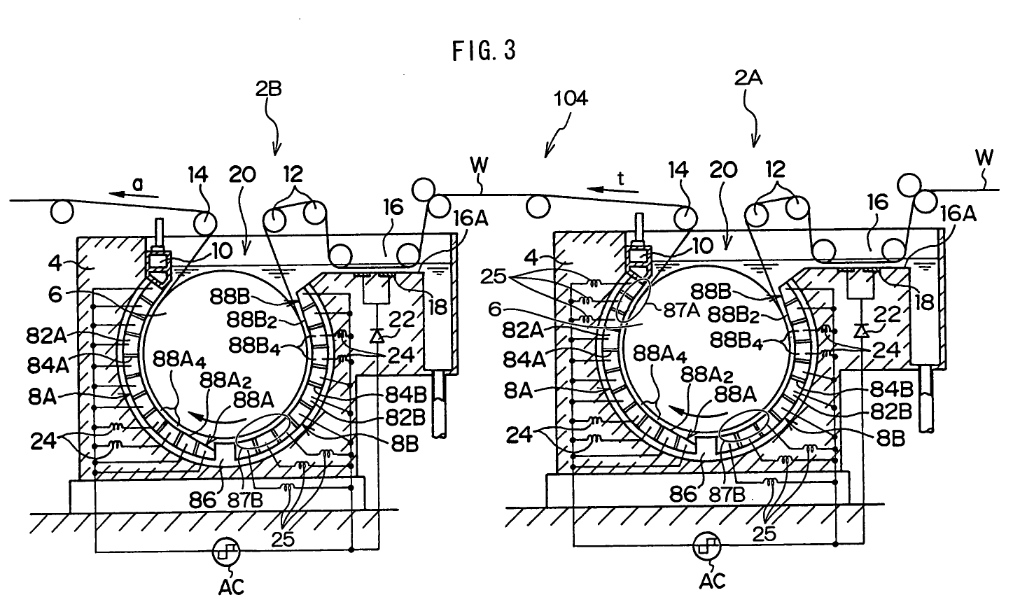

As shown in FIG. 3, in the electrolysis cell 2A that is located at the upstream side of a surface-roughening treatment apparatus 104 relating to the third embodiment, the inductance coil 25 is inserted between each of the small electrode 82A at the exit side of the electrode 8A, which is located at a downstream side with respect to the conveyance direction t, i.e., at the feeding out side where the aluminium web W is fed out and the alternating current supply AC so as to form the low current density zone 87A. Similarly, the inductance coil 25 is inserted between each of the small electrodes 82B located at the feeding out side of the electrode 8B that locates at the upstream side or the side where the aluminium web W is fed in and the alternating current supply AC to form a low current density zone 87B. As the low current density zone 87A, the low current density zone 87B is preferably formed so that the treatment time duration of the aluminum web W at the low density current zone 87B is 6% of the whole treatment time duration of the aluminium web W in the electrolysis cell 2A or longer.

In addition, the low current density zone 87B is formed in the downstream side electrolysis cell 2B as well as the electrolysis cell 2A by inserting the inductance coil 25 between each of the small electrodes 82B located at the exit side of the electrode 8B that is disposed at an upstream side with respect to the conveyance direction t, i.e., at the entrance side where the aluminium web W is introduced, and the Alternating current power supply AC. Also in the electrolysis cell 2B the low current density zone 87B is preferably formed such that a treatment time duration of the aluminium strip W thereat is at least 6% of an overall treatment time duration of the aluminium strip W in the electrolysis cell 2B.

Apart from these points, the electrolytic surface-roughening treatment apparatus 104 has structure the same as the electrolytic surface-roughening treatment apparatus relating to the first embodiment.

### EXAMPLES

### Examples 1 to 5, Reference Example 1 and Comparative Examples 1 to 4

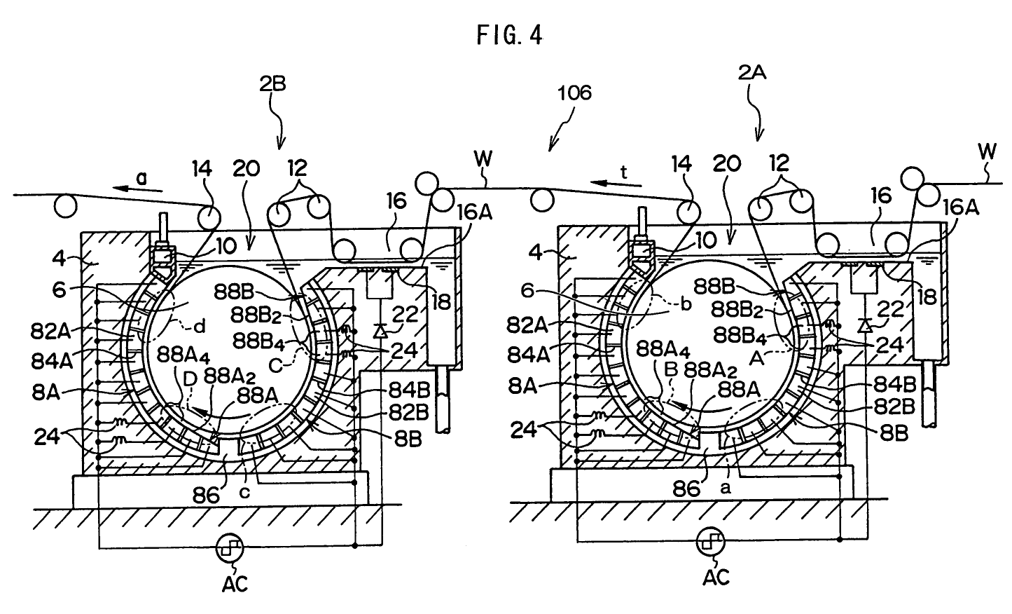

An electrolytic surface-roughening treatment was applied to an aluminium strip of width 1000 mm and thickness 0.24 mm by using an electrolytic surface-roughening treatment apparatus 106 shown in FIG. 4. A current density ratio MC_{A}/MC_{B} between the electrolysis cells 2A and 2B was set to 1.3. An entry side end portion and an exit side end portion of the electrode 8B in the electrolysis cell 2A were defined as sections A and a, respectively, and an entry side end portion and an exit side end portion of the electrode 8A were defined as sections B and b, respectively. Further, an entry side end portion and an exit side end portion of the electrode 8B in the electrolysis cell 2B were defined as sections C and c, respectively, and an entry side end portion and an exit side end portion of the electrode 8A were defined as sections D and d, respectively.

As shown in FIG. 4 and table I, in each of Examples 1 to 5, Reference Example 1 and Comparative Examples 1 to 4, the soft start portions 88A and 88B were formed in the sections A, B, C and D. On the other hand, whether or not low current density zones were formed in each of the sections a, b, c and d is as shown in table I.

In regard to quality of an aluminium strip W that had been electrolytically surface-roughened by the electrolytic surface-roughening treatment apparatus 106, the presence or absence of white shading variations, chatter marks and stripes was visually inspected, and evaluated into four grades: Excellent, Good, Unacceptable and Bad. Results are shown in table I.

TABLE I

| | | Low current density zones | | | | Chatter marks |
|---|---|---|---|---|---|---|
| | | | Treatment | | | visual |
| | Soft start | | time duration | | d | evaluation |
| | portions | Sections | (%) | d/D | (A/dm²) | result |
| Example 1 | A, B, C, D | a, b, c | 6 | 0.75 | 30 | Excellent |
| Example 2 | A, B, C, D | a, b | 6 | 0.75 | 30 | Excellent/ |
| | | | | | | Good |
| Example 3 | A, B, C, D | b | 6 | 0.38 | 15 | Good |
| Example 4 | A, B, C, D | b | 6 | 0.63 | 25 | Good |
| Example 5 | A, B, C, D | b | 6 | 0.75 | 30 | Good |
| Reference | A, B, C, D | b | 4 | 0.75 | 30 | Unacceptable |
| Example 1 | | | | | | |
| Comparative | A, B, C, D | c | 6 | 0.75 | 30 | Unacceptable |
| Example 1 | | | | | | |
| Comparative | A, B, C, D | none | — | 1.00 | 40 | Unacceptable |
| Example 2 | | | | | | |
| Comparative | A, B, C, D | none | — | 1.25 | 50 | Bad |
| Example 3 | | | | | | |
| Comparative | A, B, C, D | none | — | 1.50 | 60 | Bad |
| Example 4 | | | | | | |

As shown in table I, in Examples 1 to 5 and Reference Example 1, a low current density zone was provided at least at region b, which is located at the exit side of the electrode 8A of the electrolysis cell 2A disposed at the upstream side: white shading variations, chatter marks and stripes were barely observable at the electrolytically roughened surfaces of the aluminium strips W subsequent to the electrolytic surface-roughening treatment, and surface qualities were excellent. On the other hand, in Comparative Example 1, in which a low current density zone was provided only at the downstream side electrolysis cell 2B, and Comparative Examples 2 to 4, in which no low current density zone was provided, white shading variations, chatter marks and stripes were clearly observed at the surface of the planographic printing plate supports that were obtained.

Further, in Examples 1 to 5, a treatment time duration T of the aluminium strip W in the low current density zone of the electrolysis cell 2A disposed at the upstream side was a 6% proportion relative to the overall treatment time duration of the aluminium strip W in the electrolysis cell 2A, and planographic printing plate supports were obtained with more excellent surface quality than in Reference Example 1, in which the proportion was 4%.

Then, electrolytic surface-roughening treatments of aluminium strips were implemented in the same manner as in Examples 1 to 5, Reference Example 1 and Comparative Examples 1 to 4, that the current density ratio MC_{A}/MC_{B} between the electrolysis cells 2A and 2B was varied in the range 1.2 to 2. Results the same as in table I were obtained.

As has been described above, the present invention provides an electrolysis treatment apparatus and an electrolysis treatment process by which occurrences of surface quality defects can be effectively suppressed even when an electrolysis treatment, such as an electrolytic surface-roughening treatment or the like, is performed under a high current density and conveyance speed. A planographic printing plate support that is fabricated with the electrolysis treatment apparatus mentioned in the above is also provided by the present invention. A planographic printing plate support that is fabricated by the electrolysis treatment apparatus mentioned in the above and is free of occurrences of surface quality defects such as chatter marks is also provided as well as a planographic printing plate comprising the planographic printing plate support described in the above.

That is, in the electrolysis treatment apparatus of the present invention, in an electrolysis cell other than the electrolysis cell that is disposed furthest downstream, a low current density zone is provided at an exit region at which a metal strip is fed out. In addition, soft start portions are provided at metal strip entry regions of the electrodes.

At a soft start portion, a current density is set lower than at a region of the electrode that is further downstream along a running direction of the metal strip. Similarly, at a low current density zone, the electrolysis treatment is performed with a lower current density than at a region of the electrode that is further upstream with respect to the running direction of the metal strip. Therefore, the cathode reaction and the anode reaction are suppressed at the soft start portions. Further, because the low current density zone is formed at the exit region of the electrolysis cell except the electrolysis cell that is disposed furthest downstream, occurrences of chatter marks in the furthest downstream electrolysis cell are suppressed.

Thus, by the electrolysis treatment apparatus described above, occurrences of surface quality defects such as chatter marks on a metal strip can be suppressed.

A second aspect of the present invention is the electrolysis treatment apparatus relating to the first aspect in which, in the electrolysis cell(s) except the electrolysis cell that is disposed furthest downstream, the low current density zone is provided at an exit side end portion of the electrode that is disposed furthest downstream along the running direction of the metal strip, the exit side end portion being an end portion at a side at which the metal strip is fed out.

In the electrolysis treatment apparatus, the metal strip is surface-roughened by applying an alternating current between the electrodes and the metal strip.

Therefore, when the low current density zone is provided at the exit side end portion of the electrode that is disposed furthest downstream in the electrolysis cell except the electrolysis cell disposed furthest downstream, because the low current density zone is formed at the exit region of the electrolysis cell, occurrences of chatter marks in an electrolysis cell that is adjacent in the downstream side thereof are suppressed.

A third aspect of the present invention is the electrolysis treatment apparatus relating to the first aspect in which a plurality of the electrodes are provided in the electrolysis cell(s) except the electrolysis cell that is disposed furthest downstream, and the low current density zone is provided at the exit side end portion of each of the plurality of electrodes.

In the electrolysis treatment apparatus, because a plurality of electrodes are provided in the electrolysis cell except the electrolysis cell disposed furthest downstream, within a single electrolysis cell, it is possible that chatter marks may occur between one electrode and the other electrode which is disposed in the downstream side thereof.

However, in the electrolysis treatment apparatus, because the low current density zone is provided at the exit region side end portion of each of the plurality of electrodes, even in a single electrolysis cell, occurrence of surface quality defects such as chatter marks are effectively suppressed.

A fourth aspect of the present invention is the electrolysis treatment apparatus relating to the third aspect in which a plurality of the electrodes are also provided in the electrolysis cell that is disposed furthest downstream, and the low current density zone is provided at the exit side end portion of the plurality of electrodes except the electrode disposed furthest downstream.

When a plurality of electrodes are provided in the furthest downstream electrolysis cell, there is a possibility of occurrence of chatter marks between one electrode and the other electrode disposed in the downstream side thereof even in the furthest downstream electrolysis cell. However, in the electrolysis treatment apparatus of the fourth aspect, because the low current density zone is provided at the exit region side end portion of an electrode disposed at an upstream side in the electrolysis cell disposed furthest downstream, occurrences of surface quality defects such as chatter marks and the like are effectively suppressed in the furthest downstream electrolysis cell.

A fifth aspect of the present invention is the electrolysis treatment apparatus relating to any one of the first to fourth aspects in which a treatment time duration T of the metal strip at the low current density zone is set at least 6% of an overall treatment time duration of the metal strip in the electrolysis cell, and given that a current density of the low current density zone of the electrolysis cell is d (A/dm²) and a current density of a section except the low current density zone is D (A/dm²), d is set such that d/D≦0.75 and d≦30 A/dm².

In the electrolysis treatment apparatus relating to the fifth aspect, because the treatment time duration of the metal strip T and the current density d in the low current density zone are set as described above, occurrences of surface quality defects such as chatter marks and the like can be more effectively suppressed.

A sixth aspect of the present invention is the electrolysis treatment apparatus relating to any one of the first to fifth aspects in which the low current density zone of the electrode is formed by the exit side end portion of the electrode being formed along the running direction of the metal strip progressively further from the running path of the metal strip.

In an electrolysis treatment apparatus, when a gap between an electrode and a conveyed surface of a metal strip is large, the layer of acidic electrolyte solution that is present between the electrode and the conveyed surface is thicker, and therefore, an electrical resistance between the electrode and the metal strip is higher. Conversely, when the gap is small, the thickness of the layer of acidic electrolyte solution is smaller, and therefore electrical resistance between the electrode and the metal strip is lower.

In the electrolysis treatment apparatus relating to the sixth aspect, the exit side end portion of the electrode is formed so as to recede from the running path of the metal strip continuously along the running direction of the metal strip.

Therefore, because electrical resistance between the electrode and the metal strip increases with progress toward the downstream side with respect to the conveyance direction of the metal strip, current flowing between the electrode and the metal strip decreases with the progress to the downstream side.

Thus, in the electrolysis treatment apparatus relating to the sixth aspect, the low current density zone can be formed without any devices or components being added to a conventional electrolytic vat. Therefore, structure of the electrolysis treatment apparatus can be simplified.

A seventh aspect of the present invention is the electrolysis treatment apparatus relating to any one of the first to fifth aspects in which the electrode is divided, at least at the low current density zone, into a plurality of small electrodes which are insulated from each other, current restrictor for restricting current being provided between the small electrodes and a power supply that supplies alternating current to the small electrodes.

In the electrolysis treatment apparatus relating to the seventh aspect, at the low current density zone formed in the electrolysis cell, the electrode is divided into the small electrodes which are insulated from each other. In addition, the current restrictor is provided between the small electrodes and the power supply.

Therefore, density of alternating current at the electrode is lower at the exit side end portion of the electrode than at a central portion, that is, a region between the exit side end portion and an entrance side end portion of the electrode. As a result, occurrences of surface quality defects such as chatter marks and the like due to the metal strip that has passed along the one electrode passing along another electrode are effectively suppressed.

An eighth aspect of the present invention relates to the electrolysis treatment apparatus relating to the seventh aspect wherein the current restrictor is an inductance coils.

In the electrolysis treatment apparatus relating to the eighth aspect, impedance coils are utilized as the current restrictor.

In the above electrolysis treatment apparatus, when alternating current is supplied to a small electrode from the power supply, because the alternating current passes through the inductance coil, induction occurs and the current is restricted. Therefore, the current can be restricted without resistance losses. Furthermore, because an induction coil requires no control device at all for restriction electric current, the electrolysis treatment apparatus has an advantage in that structure is simple.

As an inductance coil, a coil which is known as an inductor and does not feature a coil with an iron core may be employed.

A ninth aspect of the present invention is the electrolysis treatment apparatus relating to the seventh aspect in which resistors are used as the current restrictor.

In the electrolysis treatment apparatus relating to the ninth aspect, because resistors are employed as the current restrictor, there are only resistance losses between the power supply and the small electrodes. Therefore, a power factor is 1.

A tenth aspect of the present invention is the electrolysis treatment apparatus relating to any one of the first to fifth aspects in which the electrode is partitioned into an exit side electrode, which is disposed at the exit side end portion and forms the low current density zone, and a central portion electrode at an upstream side of the exit side electrode with respect to the running direction of the metal strip, the exit side electrode and the central portion electrode being connected to separate power supplies.

In the electrolysis treatment apparatus relating to the tenth aspect, the electrode is partitioned into the exit side electrode and the central portion electrode as described above. In addition, the exit side electrode and the central portion electrode are connected to separate power supplies. Therefore, current density at the exit side electrode, which is to say, current density at the low current density zone, can be controlled independently from the central portion electrode.

An eleventh aspect of the present invention is the electrolysis treatment apparatus relating to any one of the first to tenth aspects in which a ratio of current densities between the electrolysis cell disposed furthest downstream and the electrolysis cell except the furthest downstream electrolysis cell is set in a range from 1:1.2 to 1:2.

In the electrolysis treatment apparatus relating to the eleventh aspect, a current density ratio between the electrolysis cell disposed furthest downstream and the other electrolysis cells is set so as to be a specific ratio. Consequently, occurrences of image quality variations can be even more effectively suppressed.

A twelfth aspect of the present invention is a support for a planographic printing plate manufactured by performing a surface-roughening treatment has been performed on an aluminum web by the electrolysis treatment apparatus relating to any one of the first to eleventh aspects.

According to the electrolysis treatment apparatus, occurrences of surface quality defects when an aluminium strip is electrolytically surface-roughened by applying an alternating current thereto can be suppressed to a minimum. Therefore, the planographic printing plate support thus provided has very small surface quality defects.

A thirteenth aspect of the present invention is a planographic printing plate comprising: the support for a planographic printing plate relating to the twelfth aspect; and a plate-making layer formed at a surface-roughened surface of the support for a planographic printing plate.

The planographic printing plate support that is used for this planographic printing plate has very small surface quality defects such as chatter marks. Therefore, by using the planographic printing plate of the present aspect, printing irregularities arising on a printing surface because of surface quality defects can be effectively suppressed.

A fourteenth aspect of the present invention is an electrolysis treatment process for performing electrolysis treatment on a metal strip that is running in a specific direction, the electrolysis treatment process including: performing the electrolysis treatment on the metal strip by sequentially passing the metal strip through a plurality of electrolysis cells that apply alternating current in an acidic electrolyte solution; in each of the electrolysis cells, disposing one electrode or two or more electrodes so as to face a running path of the metal strip, alternating current being applied to the one electrode or two or more electrodes; in each of the electrolysis cells, setting a current density at a metal strip entry region of each electrode lower than a current density at a region of the electrode at a downstream side from the entry region along the running direction of the metal strip; setting current density to be lowest in, among the plurality of electrolysis cells, the electrolysis cell that is disposed furthest downstream along the running direction of the metal strip; and in the electrolysis cell(s) except the electrolysis cell that is disposed furthest downstream, setting a current density of an exit region, at which the metal strip is fed out, to be lower than a current density of a region at an upstream side from the exit region with respect to the running direction of the metal strip.

According to the electrolysis treatment process of the present aspect, because of the same reasons as those described for the first aspect, occurrences of surface quality defects such as chatter marks on a metal strip can be suppressed.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the chart. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrolysis treatment apparatus that performs electrolysis treatment on a metal strip running in a specific direction, the electrolysis treatment apparatus comprising:
a plurality of electrolysis cells that perform electrolysis treatment continuously with alternating current in an acidic electrolyte solution, the electrolysis cells being arranged in a row along the running direction of the metal strip, and current density of the alternating current in the plurality of electrolysis cells being set so as to be lowest in the electrolysis cell that is disposed furthest downstream with respect to the running direction of the metal strip;
in each of the electrolysis cells, one or more electrodes being disposed so as to face a running path of the metal strip, alternating current being applied to the electrodes, and a soft start portion being provided at an entry region of each electrode from which the metal strip is fed in; and
in the electrolysis cell(s) except the electrolysis cell that is disposed furthest downstream, a low current density zone being provided at an exit region from which the metal strip is fed out.

2. The electrolysis treatment apparatus of claim 1 wherein, in the electrolysis cell(s) except the electrolysis cell disposed furthest downstream, the low current density zone is provided at an exit side end portion of the electrode that is disposed furthest downstream along the running direction of the metal strip, the exit side end portion being an end portion at a side at which the metal strip is fed out.

3. The electrolysis treatment apparatus of claim 2, wherein a plurality of the electrodes are provided in the electrolysis cell(s) except the electrolysis cell disposed furthest downstream, and the low current density zone is provided at the exit side end portion of each of the plurality of electrodes.

4. The electrolysis treatment apparatus of claim 3, wherein a plurality of the electrodes are also provided in the electrolysis cell disposed furthest downstream, and the low current density zone is provided at the exit side end portion of the plurality of electrodes except the electrode that is disposed furthest downstream.

5. The electrolysis treatment apparatus of claim 3, wherein an exit side end portion of the electrode is formed so as to recede continuously along the running direction of the metal strip from the running path of the metal strip so that the low current density zone of the electrode is formed at the exit side end portion.

6. The electrolysis treatment apparatus of claim 4, wherein an exit side end portion of the electrode is formed along the running direction of the metal strip progressively further from the running path of the metal strip so that the low current density zone of the electrode is formed at the exit side end portion.

7. The electrolysis treatment apparatus of claim 3, wherein the electrode is divided, at least at the low current density zone, into a plurality of small electrodes which are insulated from each other, current restrictor for restricting current being provided between the small electrodes and a power supply that supplies alternating current to the small electrodes.

8. The electrolysis treatment apparatus of claim 4, wherein the electrode is divided, at least at the low current density zone, into a plurality of small electrodes which are insulated from each other, current restrictor for restricting current being provided between the small electrodes and a power supply that supplies alternating current to the small electrodes.

9. The electrolysis treatment apparatus of claim 7, wherein the current restrictor is an inductance coil.

10. The electrolysis treatment apparatus of claim 8, wherein the current restrictor is an inductance coil.

11. The electrolysis treatment apparatus of claim 7, wherein the current restrictor is a resistor.

12. The electrolysis treatment apparatus of claim 8, wherein the current restrictor is a resistor.

13. The electrolysis treatment apparatus of claim 3, wherein the electrodes are partitioned into an exit side electrode that is disposed at the exit side end portion and forms the low current density zone, and a central portion electrode located at a position upstream of the exit side electrode with respect to the running direction of the metal strip, the exit side electrode and the central portion electrode being connected to different power supplies.

14. The electrolysis treatment apparatus of claim 4, wherein the electrodes are partitioned into an exit side electrode that is disposed at the exit side end portion and forms the low current density zone, and a central portion electrode located at a position upstream of the exit side electrode with respect to the running direction of the metal strip, the exit side electrode and the central portion electrode being connected to different power supplies.

15. The electrolysis treatment apparatus of claim 3, wherein a treatment time duration T of the metal strip at the low current density zone is set in at least 6% of an overall treatment time duration of the metal strip in the electrolysis cell, and given that a current density of the low current density zone of the electrolysis cell is d (A/dm²) and a current density of a section except the low current density zone is D (A/dm²), d is set such that d/D≦0.75 and d≦30 A/dm².

16. The electrolysis treatment apparatus of claim 4, wherein a treatment time duration T of the metal strip at the low current density zone is set in at least 6% of an overall treatment time duration of the metal strip in the electrolysis cell, and given that a current density of the low current density zone of the electrolysis cell is d (A/dm²) and a current density of a section except the low current density zone is D (A/dm²), d is set such that: d/D≦0.75 and d≦30 A/dm².

17. The electrolysis treatment apparatus of claim 3, wherein a ratio of current densities between the electrolysis cell that is disposed furthest downstream and the electrolysis(s) cell other than the most downstream electrolysis cell is set in a range from 1:1.2 to 1:2.

18. The electrolysis treatment apparatus of claim 4, wherein a ratio of current densities between the electrolysis cell that is disposed furthest downstream and the other electrolysis cell is set in a range from 1:1.2 to 1:2.

19. A support for a planographic printing plate, comprising an aluminium strip on which surface-roughening treatment has been performed by the electrolysis treatment apparatus of claim 1.

20. A planographic printing plate comprising: the support for a planographic printing plate of claim 19 and a plate-making layer formed on the side of the planographic printing plate where the surface-roughening treatment is performed.

21. An electrolysis treatment process for performing electrolysis treatment on a metal strip that is running in a certain direction, the electrolysis treatment process comprising:
performing the electrolysis treatment on the metal strip by sequentially passing the metal strip through a plurality of electrolysis cells that apply alternating current in an acidic electrolyte solution,
wherein one or more electrodes to which alternating current is applied are disposed in each electrolysis cell so as to face a running path of the metal strip, and at a metal strip entry region of each electrode current density is set lower than a current density at a region of the electrode downstream from the entry region with respect to the running direction of the metal strip;
among the plurality of electrolysis cells, current density is set so that the current density of the electrolysis cell disposed furthest downstream with respect to the running direction of the metal strip is the lowest; and
in the electrolysis cell(s) except the electrolysis cell disposed furthest downstream, current density is set so that at an exit region at which the metal strip is fed out, current density is lower than that at a region that is upstream of the exit region with respect to the running direction of the metal strip.
